(19) United States
(12) Patent Application Publication
(10) Pub. No.: US 2023/0417291 A1
(43) Pub. Date: Dec. 28, 2023

(54) CONSTANT VELOCITY JOINT BOOT

(71) Applicant: GKN Driveline North America, Inc., Auburn Hills, MI (US)

(72) Inventors: Varadarajan Balaraman, Oxford, MI (US); Michael J. Miller, White Lake, MI (US)

(21) Appl. No.: 17/848,491

(22) Filed: Jun. 24, 2022

(51) Int. Cl. F16D 3/84; F16D 3/226

(52) U.S. Cl. CPC F16D 3/845; F16D 3/2265

(57) ABSTRACT

A boot comprising a central axis and an inner surface and an outer surface. The boot having a first fastening region the inner surface of which is adapted to seal against a first component and a second fastening region the inner surface of which is adapted to seal against a second component. The boot having an interior volume between the first fastening region and the second fastening region. The boot having an intermediate region connected at a first end to the first fastening region and connected at a second end to the second fastening region. The intermediate region having a convolution located between the first end and second end, wherein the outer surface of the convolution is convex.

### TECHNICAL FIELD

The present disclosure relates generally to constant velocity joints having a polymeric boot.

### BACKGROUND

Constant velocity joints (CV joints) are often employed where transmission of a constant velocity rotary motion is desired or required. CV joints are typically greased or otherwise lubricated for the life of the component. The joints are preferably sealed to retain the lubricant inside the joint while keeping contaminants and foreign matter, such as water and dirt, out of the joint. A boot, which may be made of rubber, thermoplastic, silicone material, or the like, usually encloses portions of the CV joints. The boot provides a flexible barrier to retain the grease in the joint and extend the life of the joint.

### SUMMARY

In at least some implementations, a boot includes a central axis, an inner surface, an outer surface, a first fastening region and a second fastening region. The boot has an interior volume between the first fastening region and the second fastening region. The boot has an intermediate region connected at a first end to the first fastening region and connected at a second end to the second fastening region. And the intermediate region has a convolution located between the first end and second end, wherein the outer surface of the convolution is convex.

In at least some implementations, the first fastening region extends axially from the first end and the first fastening region is radially spaced from the second fastening region. The intermediate region having an apex at an axial outwardmost portion of the convolution wherein at least part of the outer surface of the convolution has an angled portion that extends axially inward from the first end. In at least some implementations, a channel is located axially between the first end and the apex of the convolution.

In at least some implementations, the outer surface of the intermediate region includes an axially outwardly angled portion between the apex and the second end. The intermediate region extends from the second fastening region such that the apex is positioned axially closer to the first fastening region than the second fastening region. In at least some implementations, a series of fins is located on at least a portion of the intermediate region.

In at least some implementations, multiple fins are provided on an outer surface of the intermediate region, wherein the fins extend from a radially inner end to a radially outer end with the radially outer end being closer to the second fastening region, and wherein the second fastening region axially and radially overlaps the radially outer edge of the fins. In at least some implementations, the fins have circumferentially spaced sides with a radial length and an axial width, and support ribs are provided on both of the sides of the fins. The fins may be circumferentially spaced apart, and the support ribs of one fin may be circumferentially spaced apart from the support fins of the fins circumferentially adjacent to said one fin.

In at least some implementations, the first fastening region includes a channel between the first end and circumferentially spaced projections that each have a retention surface adjacent to the channel and defining an edge of the channel. The projections may be compressible to permit a retaining ring to pass over the projections and enter the channel, and the projections are resilient to return to or toward their uncompressed state when not compressed.

In at least some implementations, a constant velocity joint includes an outer race, an inner race, a cage located between the inner race and the outer race, multiple balls retained by the cage, a shaft extending from the inner race, and a boot that is annular and has a central axis. The boot having an inner surface and an outer surface. The boot having a first fastening region the inner surface of which is in contact with the outer race. The boot having a second fastening region which is in contact with at least one of the inner race and the shaft. The boot having an intermediate region connected at a first end to the first fastening region and connected at a second end to the second fastening region. The intermediate region includes a convolution located between the first end and second end, and wherein the outer surface of the convolution is convex. The boot comprises an interior volume between the first fastening region and the second fastening region.

In at least some implementations, the convolution has an apex at an axial outwardmost portion of the convolution and at least part of the outer surface of the convolution has an angled portion that extends axially inward from the first end. The apex is circumferentially located at the axial outwardmost portion of the convolution of the boot and is positioned radially closer to the first fastening region than the second fastening region.

Various features and components may be combined together except where they are mutually exclusive, in accordance with the description below, which is intended to illustrate the various features rather than limit the inventions described herein.

### BRIEF DESCRIPTION OF THE DRAWINGS

The following detailed description of preferred implementations and best mode will be set forth with regard to the accompanying drawings, in which:

FIG. 1 is a cross sectional view of a CV joint including the boot;

FIG. 2 is a perspective and fragmentary sectional view of the boot;

FIG. 3 is a perspective view of the boot removed from the CV joint;

FIG. 4 is a perspective view of a boot for a CV joint;

FIG. 5 is another perspective view of the boot of FIG. 4;

FIG. 6 is a plan view of the boot;

FIG. 7 is a sectional view taken generally along line 7-7 in FIG. 6;

FIG. 8 is an enlarged sectional view of a portion of the boot; and

FIG. 9 is an enlarged sectional view of a portion of the boot.

### DETAILED DESCRIPTION

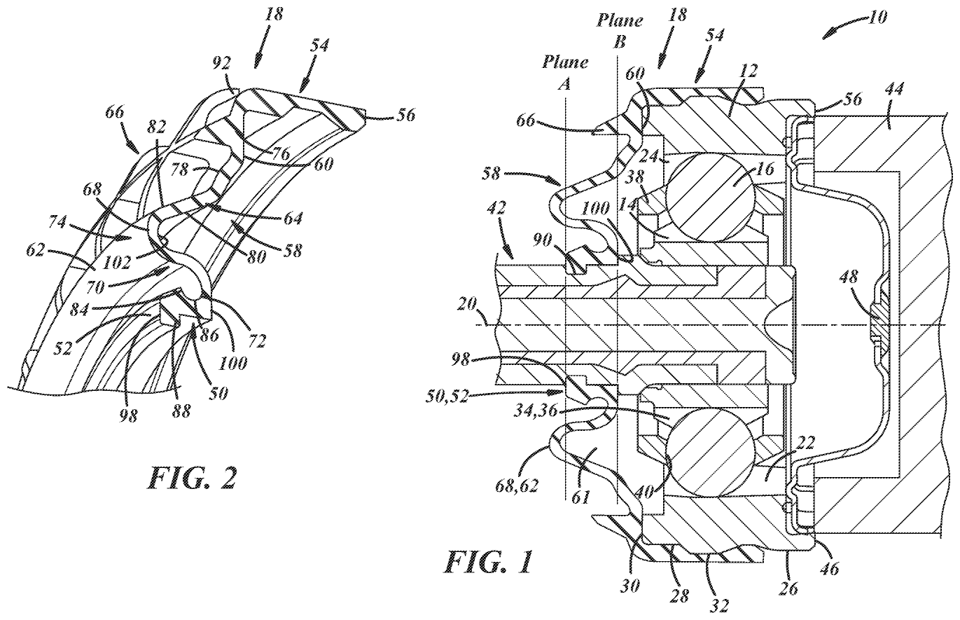

Referring in more detail to the drawings, FIG. 1 illustrates a constant velocity joint (CV Joint) that may be used, for example, with half shafts, interconnecting shafts and propeller shafts of these vehicles, or otherwise as desired. The CV joint 10 may have an outer race 12 and an inner race 14 pivotally coupled to one another and having multiple ball tracks in which a plurality of torque transmitting members, like rollers or balls 16, are received so that the inner race 14 and outer race 12 co-rotate. The CV joint 10 may be any type of constant velocity joint, such as a tripod, double offset, cross-groove, Rzeppa, and the like. And as set forth herein, a boot 18 may be coupled to the CV joint 10.

The outer race 12 has a central axis 20 about which the outer race 12 rotates, and an inner surface 22 with multiple outer ball tracks 24 defined in the inner surface 22. To facilitate coupling the boot 18 to the outer race 12, the outer race 12 may include, in an outer surface 26, a mounting surface 28 at or adjacent to a first axial end 30 of the outer race 12. The mounting surface 28 may be annular and extend circumferentially around the outer race 12. And the mounting surface 28 may include a radially outwardly extending portion 32, or a radially inwardly extending groove, defining a seat or sealing surfaces for the boot 18. In one embodiment, the outwardly extending portion 32 may be a continuous rim that extends around the circumference of the outer race 12; although the outwardly extending portion 32 may include multiple teeth or ridges spaced circumferentially around the outer surface 26 of the outer race 12, if desired. The outer race 12 is generally made of metal, such as steel, however, any other type of metal material, plastic, or composite material, etc., may also be used for the outer race in at least some implementations.

The inner race 14 may be received at least partially within (e.g. axially overlapped by) the outer race 12 and may have an outer surface 34 in which multiple inner ball tracks 36 are defined. The inner ball tracks 36 in the inner race 14 are aligned with the outer ball tracks 24 in the outer race 12 and the balls 16 are positioned between the inner race 14 and outer race 12 with each ball received within a respective one of the outer ball tracks 24 and inner ball tracks 36. The inner race 14 may be made of steel, however, any other metal composite, hard plastic, etc., may also be used.

To help retain the balls 16 between the outer race 12 and inner race 14, a cage 38 with openings 40 in which the balls are located is received between the outer race 12 and inner race 14. The cage 38 may be annular, at least partially axially overlapped by the outer race 12 and the inner race 14 (and radially between the races), and may be made of a steel material but other metal materials, plastics, composites, etc. may also be used.

In at least some implementations, a first shaft or first rotary component 42 is coupled to the inner race 14 and a second shaft or second rotary component 44 is coupled to the outer race 12. The balls 16 permit pivoting of the inner race 14 relative to the outer race 12 and thus, pivoting of the first rotary component 42 relative to the second rotary component 44 while the rotary components rotate together, at the same rotational velocity.

On or at a second axial end 46 of the outer race 12, a grease cap 48 may be provided to retain grease or other suitable lubricant within the CV joint 10 and inhibit contaminants from entering the joint. Grease cap 48 may also contain a venting mechanism (not shown) that allows for high pressure gas to be expelled during joint operation. Opposite to the grease cap 48, the boot 18 may enclose at least part of the CV joint 10 to retain grease within the joint and inhibit entry of contaminants into the joint.

In at least some implementations, the boot 18 may be annular and have a central axis (which may be coaxial with the outer race axis 20). In at least some implementations, as shown in FIGS. 1 and 2, the boot 18 has a first fastening region 50 at a first axial end 52 and a second fastening region 54 at a second axial end 56. The first fastening region 50 may extend axially from the first end 52 and may be radially spaced from the second fastening region 54. The first fastening region 50 is arranged to be coupled to the inner race 14 and/or to the first rotary component 42 and may have a smaller diameter than the second fastening region 54 that is adapted to be received over and sealed to the mounting surface 28 of the outer race 12. The boot 18 may further comprise an intermediate region 58 located between the first fastening region 50 and the second fastening region 54.

So arranged, an interior surface 60 between the first fastening region 50 and the second fastening region 54 of the boot 18 defines part of an interior volume 61 (FIG. 1) of the CV joint in which the cage 38 and balls 16 are located, and an opposite, exterior surface 62 of the boot 18 defines part of an exterior of the CV joint 10. The boot 18 may be constructed of a flexible material, such as, but not limited to, rubber-based products, plastics, urethane, silicones, elastomers, silicone, thermoplastic elastomer (TPE), and any other flexible composite materials. The boot 18 can be produced in an injection molding process. It is understood however, that boot 18 may comprise any other suitable material that is sufficiently flexible to allow the CV joint 10 to operate through a wide range of angles.

In at least some implementations, starting from the second fastening region 54 and moving radially to the first fastening region 50, the intermediate region 58 includes: an axially outwardly angled or curved portion 64 that includes at least part of a series of fins 66 (discussed in more detail below) and leads to an axial apex 68, that leads to an axially inwardly angled or curved portion 70, that leads to a channel 72 at the first fastening region 50. The axially outwardly angled portion 64 may be located between the apex 68 and the second end 56. The axially inwardly angled portion 70 may be located between the apex 68 and the first end 52. In this context, axially outward and inward are relative to the interior 61 of the CV joint 10. A convolution 74 is defined by the axially outwardly and inwardly angled or curved potions 64, 70 and includes the apex 68 that is circumferentially located at an axial outwardmost portion of the convolution 74.

In the example shown in FIG. 2, the intermediate region 58 includes a radially outward portion 76 that extends radially from the second fastening region 54 to an inclined or curved portion 78 that extends radially inwardly to the convolution 74 and which also extends axially away from the second fastening region 54. The radius of a curvature in the curved portion 78 may depend upon and be selected to accommodate a radius of the balls 16. As such, the intermediate region 58 extends from an end of the second fastening region 54 opposite to the second axial end 56 of the boot 18, such that the apex 68 is offset from the second fastening region 54 and is positioned axially closer to and may overlap the first axial end 52 than the second axial end 56. In at least some implementations, the apex may be radially closer to the first fastening region 50 than the second fastening region 54.

Thus, in an at rest state of the boot 18, which is the state that the boot is in without external forces acting on the boot to flex or deform the boot, the convolution 74 is U-shaped with an interior surface 80 of the convolution 74 being concave and the exterior surface 82 of the convolution 74 being convex. So formed at least part of the intermediate region 58, including the convolution 74, the channel 72, and the first fastening region 50 define an S-shape.

The channel 72 is defined by a radially inward part of the convolution 74, and a radially outwardly extending lip 84 with a base 86 of the channel 72 located axially between these features. In other words, the channel 72 may be located axially between the first end 52 and the apex 68 of the convolution 74. In use, a retaining ring (not shown) is received within the channel 72 with the base 86 trapped between the first rotary component 42 and the retaining ring, to retain the boot 18 connected to the first rotary component 42. To further improve the retention of the first fastening region 50 on the first rotary component 42 and/or a seal between them, the first fastening region 50 may include a radially inwardly extending lip 88 adapted to be received within a groove 90 (FIG. 1) in the first rotary component 42.

As shown in FIGS. 1-3, the exterior surface of the boot 62 may be defined by or include the series of fins 66 that extend axially outwardly from the exterior surface and that are at least partially located between the second fastening region 54 and the apex 68 of the convolution 74. The fins 66 may be oriented in any desired manner, and are shown in a grid-like fashion including interconnected circumferentially and axially extending fins, that have a radial thickness, and fins that extend axially and radially, with a thickness in the circumferential direction.

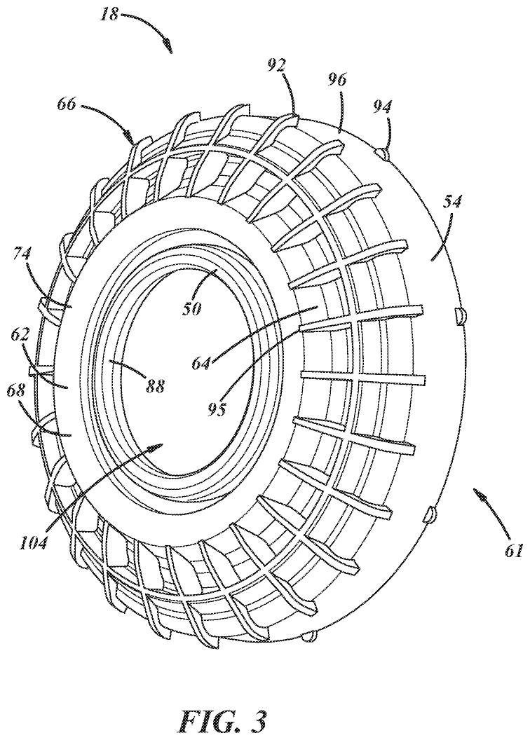

The fins 66 may be located radially between at least part of the convolution 74 and the second fastening region 54. A radially outer end of at least some fins may extend radially beyond at least part of the second fastening region 54, and may each provide a tab 92 arranged to inhibit movement in that direction of a retaining ring used to couple the boot 18 to the outer race 12, as set forth in more detail below. The boot 18 may include discrete tabs 94 or an annular lip axially spaced from the tabs to define a seat 96 between them. A radially inward end 95 (FIG. 3) of at least some fins may be overlapped with part of the convolution 74, such as the axially outwardly angled portion 64 that is radially outboard of the apex 68, or the fins 66 may be radially spaced from the convolution 74, as desired. The fins 66 may strengthen or stiffen that portion of the boot 18 to, for example, counteract high centrifugal forces and any tendency the boot 18 may have to bend or flex at high rotational speeds.

In at least some implementations, and relative to the interior of the CV joint 10, the apex 68 of the convolution 74 may be located radially outwardly of the first fastening region 50. This is shown in FIG. 1 with reference to imaginary plane A, which is perpendicular to the central axis 20 and which intersects an axially outer surface 98 of the first fastening region 50 or other radially innermost portion of the boot 18. The plane A intersects the convolution 74 axially inboard of the apex 68. In at least some implementations, the second fastening region 54 is axially offset from and does not overlap the first fastening region. This is shown by reference to imaginary plane B which is perpendicular to the central axis 20 and which intersects an axially inner surface 100 of the first fastening region 50 or other radially innermost portion of the boot 18 (not including the lip 84) and which intersects the intermediate portion between the apex 68 and the second fastening region 54.

Thus, the first fastening region 50 and the channel 72 are located between planes A and B. Further, a majority of the convolution 74, that is, more than one-half of the axial extent of the convolution 74, also is located between the planes A and B in at least the at rest state of the boot 18. In at least some implementations, an inner surface 102 of the convolution 74 radially inwardly of the apex 68 is axially outward of reference plane B. Further, in at least some implementations, the entire convolution 74 is axially spaced from and not axially overlapped by the second fastening region 54. And in at least some implementations, the entire intermediate region 58 is axially spaced from and not axially overlapped by the second fastening region 54.

In the at rest state of the boot 18, the first fastening portion 50 may be coaxial with the second fastening portion 54. In use, the first rotary component 42 may pivot relative to the second rotary component 44 and thus, the axis of the first fastening region moves relative to the second fastening region 54 such that the fastening regions do not remain coaxial throughout use of the CV joint. The convolution 74 accommodates movement of the first fastening region 50 relative to the second fastening region 54. Further, the convolution 74 having a convex exterior surface 82 enables a higher range of pivoted movement of the first fastening region 50 relative to the second fastening region 54 than would an oppositely, inwardly curved convolution 74 (i.e., with a concave exterior surface) which is more likely to be pinched between adjacent components of the CV joint 10.

In assembly, the boot 18 is installed onto the outer race 12 with the second fastening region 54 overlapping at least part of the mounting surface 28. A retaining ring (not show) is installed on the seat 96 of the boot, and the retaining ring traps the second fastening region 54 against the mounting surface 28 of the outer race 12, and provides a seal between them. Further, the first rotary component 42 is inserted into an opening 104 (FIG. 3) defined by the first fastening region 50. The lip 88, if provided, is installed in the groove 90 of the first rotary component 42, and a second retaining ring (not shown) received in the channel 72 traps a portion of the boot 18 that defines the base 86 of the channel 72 against the first rotary component 42, and provides a seal between them.

So arranged, the first fastening region 50 moves with and not relative to the first rotary component 42, and the second fastening region 54 is fixed against and does not move relative to the outer race 12. Movement of the first rotary component 42 relative to the outer 12 race causes flexing and deformation of the boot 18 from its at rest state. A wide range of motion is accommodated by the boot 18.

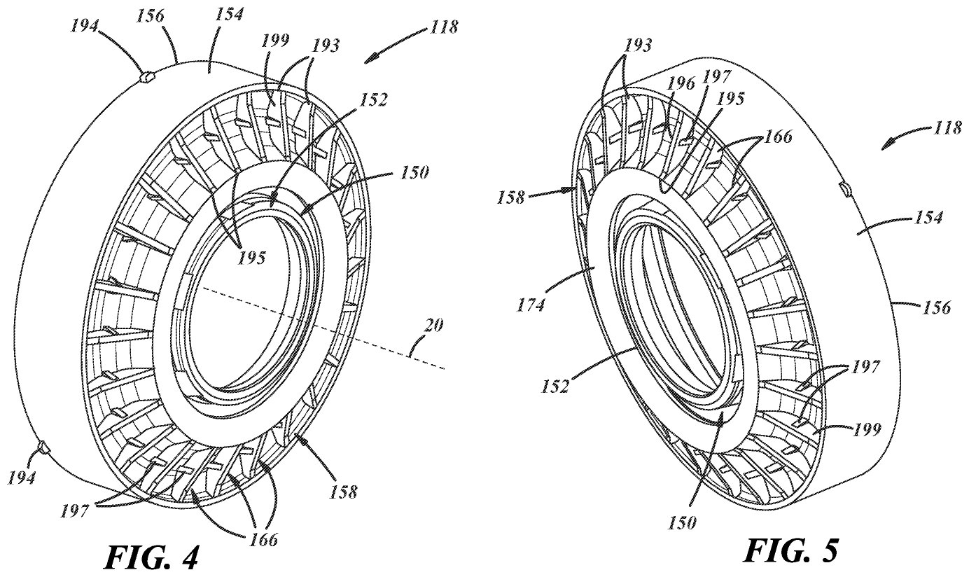

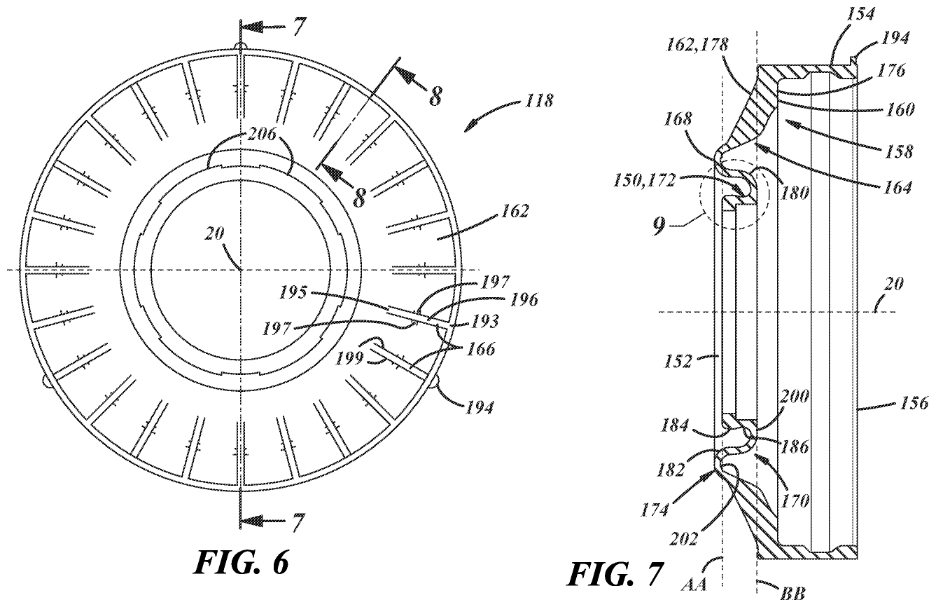

Another implementation of a boot 118 is shown in FIGS. 4-9, and this boot may be used with a CV joint as shown in FIG. 1 and will be described with reference to such a joint. In at least some implementations, the boot 118 may be annular and have a central axis (which may be coaxial with the outer race axis 20). In at least some implementations, as shown in FIGS. 4-6, the boot 118 has a first fastening region 150 at a first axial end 152 and a second fastening region 154 at a second axial end 156. The first fastening region 150 may extend axially from the first end 152 and may be radially spaced from the second fastening region 154. The first fastening region 150 is arranged to be coupled to the inner race 14 and/or to the first rotary component 42 and may have a smaller diameter than the second fastening region 154 that is adapted to be received over and sealed to the mounting surface 28 of the outer race 12. The boot 118 may further comprise an intermediate region 158 located between the first fastening region 150 and the second fastening region 154.

So arranged, an interior surface 160 between the first fastening region 150 and the second fastening region 154 of the boot 118 defines part of an interior volume of the CV joint in which the cage 38 and balls 16 are located, and an opposite, exterior surface 162 of the boot 118 defines part of an exterior of the CV joint 10. The boot 118 may be constructed of a flexible material, such as, but not limited to, rubber-based products, plastics, urethane, silicones, elastomers, silicone, thermoplastic elastomer (TPE), and any other flexible composite materials. The boot 118 can be produced in an injection molding process. It is understood however, that boot 118 may comprise any other suitable material that is sufficiently flexible to allow the CV joint 10 to operate through a wide range of angles.

In at least some implementations, starting from the second fastening region 154 and moving radially to the first fastening region 150, and with reference to FIG. 7, the intermediate region 158 includes: an axially outwardly angled or curved portion 164 that includes at least part of a series of fins 166 (labelled in FIGS. 4-6) discussed in more detail below) and leads to an axial apex 168, that leads to an axially inwardly angled or curved portion 170, that leads to a channel 172 at the first fastening region 150. The axially outwardly angled portion 164 may be located between the apex 168 and the second end 156. The axially inwardly angled portion 170 may be located between the apex 168 and the first end 152. In this context, axially outward and inward are relative to the interior of the CV joint 10. A convolution 174 is defined by the axially outwardly and inwardly angled or curved potions 164, 170 and includes the apex 168 that is circumferentially located at an axial outwardmost portion of the convolution 174.

In at least some implementations, the intermediate region 158 includes a radially outward portion 176 that extends radially from the second fastening region 154 to an inclined portion 178 that extends radially inwardly to the convolution 174 and which also extends axially away from the second fastening region 154. The angle of the inclined portion 178 may range between 45 and 90 degrees, and the inner surface in this area may be concave or otherwise formed to provide clearance from the balls and/or cage of the CV joint. As such, the intermediate region 158 extends from an end of the second fastening region 154 opposite to the second axial end 156 of the boot 118, such that the apex 168 is offset from the second fastening region 154 and is positioned axially closer to and may overlap the first axial end 152 than the second axial end 156. In at least some implementations, the apex may be radially closer to the first fastening region 150 than the second fastening region 154.

Thus, in an at rest state of the boot 118, which is the state that the boot is in without external forces acting on the boot to flex or deform the boot, the convolution 174 is U-shaped with an interior surface 180 of the convolution 174 being concave and the exterior surface 182 of the convolution 174 being convex. So formed at least part of the intermediate region 58, including the convolution 174, the channel 172, and the first fastening region 150 define an S-shape.

The channel 172 is defined by a radially inward part of the convolution 174, and a radially outwardly extending lip 184 with a base 186 of the channel 172 located axially between these features. In other words, the channel 172 may be located axially between the first end 152 and the apex 168 of the convolution 714. In use, a retaining ring (not shown) is received within the channel 172 with the base 186 trapped between the first rotary component 42 and the retaining ring, to retain the boot 118 connected to the first rotary component 42. To further improve the retention of the first fastening region 150 on the first rotary component 42 and/or a seal between them, the first fastening region 150 may include a radially inwardly extending lip 188 (FIG. 9) adapted to be received within a groove 90 (FIG. 1) in the first rotary component 42.

As shown in FIGS. 4 and 5, among other views, the exterior surface of the boot 162 may be defined by or include the series of fins 166 that extend axially outwardly from the exterior surface and that are at least partially located between the second fastening region 154 and the apex 168 of the convolution 174. The fins 166 may be oriented in any desired manner, and are shown arranged circumferentially spaced apart, with a radial length, circumferential thickness, and an axial height.

As shown in FIGS. 4, 5 and 8, the fins 166 may be located radially between at least part of the convolution 74 and the second fastening region 154. A radially outer end 193 of at least some fins may extend to or radially beyond at least part of the second fastening region 154. The boot 118 may include discrete tabs 194 or an annular lip extending radially from the second fastening region to help maintain a retaining ring on the second fastening region in assembly, as described above. A radially inner end 195 (FIGS. 4-6 and 8) of at least some fins 166 may be overlapped with part of the convolution 174, such as the axially outwardly angled portion 164 that is radially outboard of the apex 168, or the fins 166 may be radially spaced from the convolution 174, as desired. An axial outer surface 196 of the fins 166 may be generally planar, along at least a majority of the radial length of the fins. The fins 166 may strengthen or stiffen that portion of the boot 118 to, for example, counteract high centrifugal forces and any tendency the boot 118 may have to bend or flex at high rotational speeds.

Each fin 166 may have, on one or both circumferential spaced apart sides 199 (which have a radial length and an axial width), support ribs 197 that extend along the axial height, and which have a limited circumferential extent such that, in at least some implementations, the support ribs 197 of one fin 166 are spaced circumferentially from the support ribs 197 of adjacent fins 166. In at least some implementations, the circumferential extent of each support rib 197 may be equal to or within 50% of equal to the circumferential thickness of each fin 166, and the radial extent of each support rib 197 may be equal to or within 50% of equal to the circumferential thickness of each fin 166. The support ribs 197 may be provided between the radial inner and outer ends 193, 195 of each fin 166. The support ribs 197 may inhibit flexing or buckling in the circumferential direction of the fins 166, and help to maintain the fins 166 in a straight, radial orientation.

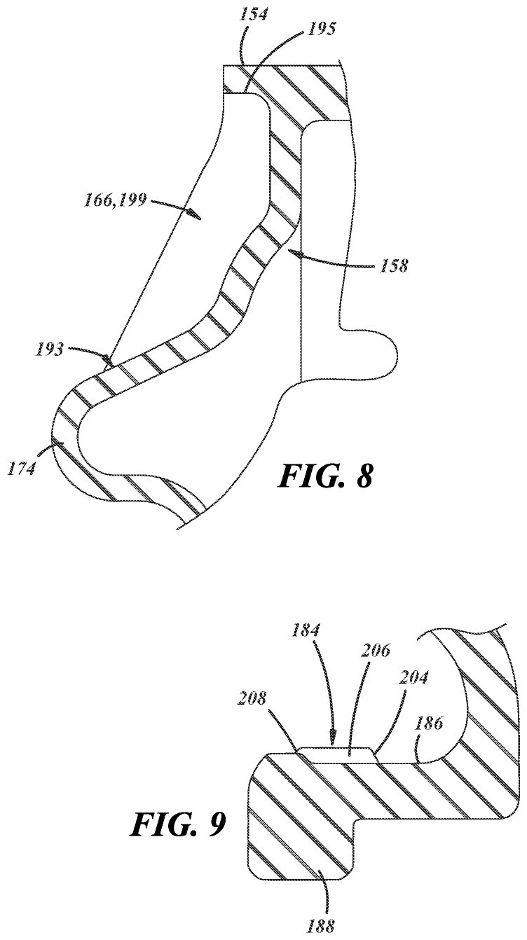

In at least some implementations, as shown in FIGS. 4, 5 and 8, the radially outer end 193 of the fins 166 are axially and radially overlapped by the second fastening region 154. When a retaining ring is installed over the second fastening region 154, the fins are supported against outward radial deformation by the retaining ring. This overlap may be present over all (as shown in FIG. 8) or some part of the radially outer end 193 of the fins 166, and the second fastening region 154 may be continuous between the fins, that is, form a continues, complete annular surface having a generally planar outer edge adjacent to the fins.

In at least some implementations, and relative to the interior of the CV joint 10, the apex 168 of the convolution 174 may be located radially outwardly of the first fastening region 150. This is shown in FIG. 7 with reference to imaginary plane AA, which is perpendicular to the central axis 20 and which intersects an axially outer surface 198 of the first fastening region 150 or other radially innermost portion of the boot 118. The plane AA intersects the convolution 174 axially inboard of the apex 168. In at least some implementations, the second fastening region 154 is axially offset from and does not overlap the first fastening region. This is shown by reference to imaginary plane BB which is perpendicular to the central axis 20 and which intersects an axially inner surface 200 of the first fastening region 150 or other radially innermost portion of the boot 118 (not including the lip 184) and which intersects the intermediate portion between the apex 168 and the second fastening region 154.

Thus, the first fastening region 150 and the channel 172 are located between planes AA and BB. Further, a majority of the convolution 174, that is, more than one-half of the axial extent of the convolution 174, also is located between the planes AA and BB in at least the at rest state of the boot 118. In at least some implementations, an inner surface 202 of the convolution 174 radially inwardly of the apex 168 is axially outward of reference plane BB. Further, in at least some implementations, the entire convolution 174 is axially spaced from and not axially overlapped by the second fastening region 154. And in at least some implementations, the entire intermediate region 158 is axially spaced from and not axially overlapped by the second fastening region 154.

In the at rest state of the boot 118, the first fastening portion 150 may be coaxial with the second fastening portion 154. In use, the first rotary component 42 may pivot relative to the second rotary component 44 and thus, the axis of the first fastening region 150 moves relative to the second fastening region 154 such that the fastening regions do not remain coaxial throughout use of the CV joint. The convolution 174 accommodates movement of the first fastening region 150 relative to the second fastening region 154. Further, the convolution 174 having a convex exterior surface 182 enables a higher range of pivoted movement of the first fastening region 150 relative to the second fastening region 154 than would an oppositely, inwardly curved convolution 174 (i.e., with a concave exterior surface) which is more likely to be pinched between adjacent components of the CV joint 10.

The boot 118 may be installed onto the joint 10 in the same manner described above with regard to boot 18, and may function like boot 18. Accordingly, the assembly and function of the boot 118 will not be further described with the exception of the assembly of a retaining ring into the first fastening region. In at least some implementations, retaining surfaces 204 are provided adjacent to the channel 172, as shown in FIGS. 4-7 and 9, and as labelled in FIG. 9. The retaining surfaces 204 may be defined by circumferentially spaced apart projections 206 provided between the first axial end 152 and the channel 172 and defining the lip 184. The projections 206 may be compressible to permit a retaining ring to pass over them and resilient to return to or toward their uncompressed state after the retaining ring passes over them. The retaining surface 204 of each projection 206 may extend radially and provide a barrier against relative movement between the material of the boot and the retaining ring which would tend to move the retaining ring out of the channel in the direction of the first axial end 152. If desired, an axially outer portion 208 of the projections 206 may be radially inclined providing a ramp tor facilitate assembly of the retaining ring over the projections 206 and into the channel 172.

Advantages realized by the disclosure may be applied to substantially all types of constant velocity joints, and, therefore, the disclosure should not be limited to the illustrated embodiments. Further, references in the specification to “one embodiment” or “an embodiment” or “an implementation” or “at least some implementations” means that a particular feature, structure, or characteristic described in connection with the embodiment is included in at least one embodiment. The appearances of the phrase “in one embodiment” in various places in the specification are not necessarily all referring to the same embodiment.”

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A boot comprising:
a central axis, an inner surface and an outer surface, the boot having a first fastening region the inner surface of which is adapted to seal against a first component, the boot having a second fastening region the inner surface of which is adapted to seal against a second component, the boot having an interior volume between the first fastening region and the second fastening region, and the boot having an intermediate region connected at a first end to the first fastening region and connected at a second end to the second fastening region, wherein the intermediate region includes a convolution located between the first end and second end, and wherein the outer surface of the convolution is convex.

2. The apparatus of claim 1 wherein the first fastening region extends axially from the first end, and wherein the first fastening region is radially spaced from the second fastening region.

3. The apparatus of claim 1 wherein the intermediate region has an apex at an axial outwardmost portion of the convolution, and wherein at least part of the outer surface of the convolution has an angled portion that extends axially inward from the first end.

4. The apparatus of claim 3 wherein a channel is located axially between the first end and the apex of the convolution.

5. The apparatus of claim 1 wherein the outer surface of the intermediate region includes an axially outwardly angled portion between the apex and the second end.

6. The apparatus of claim 1 wherein the intermediate region extends from the second fastening region such that the apex is positioned axially closer to the first fastening region than the second fastening region.

7. The apparatus of claim 1 wherein a series of fins is located on at least a portion of the intermediate region.

8. The apparatus of claim 1 wherein multiple fins are provided on an outer surface of the intermediate region, wherein the fins extend from a radially inner end to a radially outer end with the radially outer end being closer to the second fastening region, and wherein the second fastening region axially and radially overlaps the radially outer edge of the fins.

9. The apparatus of claim 8 wherein the fins have circumferentially spaced sides with a radial length and an axial width, and support ribs are provided on both of the sides of the fins.

10. The apparatus of claim 9 wherein the fins are circumferentially spaced apart, and wherein the support ribs of one fin are circumferentially spaced apart from the support fins of the fins circumferentially adjacent to said one fin.

11. The apparatus of claim 1 wherein the first fastening region includes a channel between the first end and circumferentially spaced projections that each have a retention surface adjacent to the channel and defining an edge of the channel.

12. The apparatus of claim 11 wherein the projections are compressible to permit a retaining ring to pass over the projections and enter the channel, and the projections are resilient to return to or toward their uncompressed state when not compressed.

13. The apparatus of claim 1 wherein the entire convolution is axially spaced from and not axially overlapped by the second fastening region.

14. A constant velocity joint, comprising:
an outer race;
an inner race;
a cage located between the inner race and the outer race;
multiple balls retained by the cage;
a shaft extending from the inner race; and
a boot that is annular and has a central axis, an inner surface and an outer surface, the boot having a first fastening region which is in contact with at least one of the inner race and the shaft, the boot having a second fastening region the inner surface of which is in contact with the outer race, and the boot having an intermediate region connected at a first end to the first fastening region and connected at a second end to the second fastening region, wherein the intermediate region includes a convolution located between the first end and second end, and wherein the outer surface of the convolution is convex.

15. The apparatus of claim 14 wherein the boot comprises an interior volume between the first fastening region and the second fastening region.

16. The apparatus of claim 14 wherein the convolution has an apex at an axial outwardmost portion of the convolution, and wherein at least part of the outer surface of the convolution has an angled portion that extends axially inward from the first end.

17. The apparatus of claim 14 wherein the apex is circumferentially located at the axial outwardmost portion of the convolution of the boot and is positioned radially closer to the first fastening region than the second fastening region.

18. The apparatus of claim 14 wherein multiple fins are provided on an outer surface of the intermediate region, wherein the fins extend from a radially inner end to a radially outer end with the radially outer end being closer to the second fastening region, and wherein the second fastening region axially and radially overlaps the radially outer edge of the fins.

19. The apparatus of claim 18 wherein the fins have circumferentially spaced sides with a radial length and an axial width, and support ribs are provided on both of the sides of the fins.

20. The apparatus of claim 14 wherein the first fastening region includes a channel between the first end and circumferentially spaced projections that each have a retention surface adjacent to the channel and defining an edge of the channel, and wherein the projections are compressible to permit a retaining ring to pass over the projections and enter the channel, and the projections are resilient to return to or toward their uncompressed state when not compressed.
